(19) United States
(12) Patent Application Publication
(10) Pub. No.: US 2017/0198770 A1
(43) Pub. Date: Jul. 13, 2017

(54) SAFETY CLAMPING AND/OR SAFETY BRAKING DEVICE

(71) Applicant: HEMA Maschinen Und Apparateschutz GmbH, Seligenstadt (DE)

(72) Inventor: Edmund LIKUS, Seligenstadt (DE)

(21) Appl. No.: 15/307,147

(22) PCT Filed: Apr. 29, 2015
(86) PCT No.: PCT/EP2015/059379

§ 371 Date: Jan. 6, 2017

(30) Foreign Application Priority Data
Apr. 29, 2014 (DE) 10 2014 208 107.6

(51) Int. Cl. F16D 63/00; F16D 55/224

(52) U.S. Cl. CPC F16D 63/002; F16D 63/008; F16D 55/2245; F16D 2121/04

(57) ABSTRACT

A clamping and/or braking device (1), which comprises at least two clamping elements (3a, 3b) each having a slave piston (4a, 4b) that triggers the clamping and/or braking action and an actuator system for generating a force that is transmitted to the slave pistons (4a, 4b), is intended to meet the highest safety requirements and standards, despite its particularly energy-efficient and compact design. The actuator system is also formed as a double-actuator system (10),

The invention relates to a safety clamping and/or safety braking device for machine elements, comprising at least two clamping elements each having a slave piston that triggers the clamping and/or braking action and an actuator system for generating a force that is transmitted to the slave pistons.

Clamping and/or braking devices are used in a wide variety of designs and in various fields of use. Linear clamping or braking systems are used similarly both when precisely fixing tools or workpieces to a linear rail and when protecting against undesired falling or sliding along such a rail. Said systems are also used for emergency braking of rapidly rotating machine shafts or disc brakes.

In order to transmit force from an external control system of the clamping and/or braking device to the element to be either braked or clamped, in such devices an electromagnetic, pneumatic or hydraulic actuator system can be used, in which a master piston is first actuated. The braking or clamping force is transmitted from said master piston to a slave piston, which in turn can act on the force output side, for example directly on the element to be either braked or clamped. In braking systems, in view of the friction and the like that needs to be taken into consideration, a brake block is generally also switched between the slave piston and the element to be braked. The slave piston therefore triggers both the braking and the clamping action in both cases.

In this case, a distinction is in principle made between active clamping or braking systems, in which the braking force is actively induced from the outside when braking, and passive clamping or braking systems, in which the clamping or braking system is closed when in the idle state and can only be opened by the application of force. In this latter case, a compression spring is usually pre-tensioned, which spring is released when braking and therefore transmits the force stored in the spring to the brake piston. Depending on the field of use and prescribed safety conditions, an active or passive clamping or braking system is therefore utilised. Existing clamping or braking systems are disadvantageous in that the maximum achievable braking force of the passive clamping or braking system is restricted either by the spring and the maximum amount of pre-tensioning made possible by said spring, or by the force of the actuator system that can be supplied from the outside. However, when higher safety requirements are placed on the clamping or braking system, this may, in some circumstances, be insufficient or may only be achieved by using high amounts of energy or correspondingly large actuator systems.

Therefore, the object of the invention is to provide a safety clamping and/or safety braking device for machine elements of the above-mentioned type, which device can meet the highest safety requirements and standards despite its particularly energy-efficient and compact design.

This object is achieved according to the invention by the actuator system being formed as a double-actuator system,

In this case, the invention proceeds from the consideration that, in order to fulfil safety requirements and standards, the clamping or braking force, and the reaction time until the complete clamping or braking action occurs, are of particular relevance. In order to fulfil both criteria, the force of the actuator system, which acts on the slave pistons and slides them towards the element to be braked, is particularly important. Therefore, for a design that is as energy-efficient and compact as possible, not only is the clamping or braking force divided among a plurality of slave pistons, but the actuator system is also formed as a double-actuator system. By dividing said force among a plurality of actuators, the overall actuator stroke required can be reduced. This means that the actuator stroke can be halved in the double actuator, so that the actuators can be operated during the starting phase using significantly lower amounts of energy and can therefore also be more compact. It has in particular been found that, during the starting phase that is essential for clamping and braking elements, the starting current required increases disproportionately to the starting stroke. By designing the actuator system as a double-actuator, the magnetic force generated can be divided between two actuator systems, and therefore less energy has to be expended overall for the two actuator systems.

In a preferred embodiment, the clamping elements are formed as passive clamping elements. This means that a force has to be applied to the clamping elements in order to hold the clamping elements in an open position, i.e. in a position in which the braking elements are not in frictional contact with the component to be braked. This leads to emergency clamping or braking also being possible or in particular being triggered when the energy supply to the system is cut off.

In an advantageous embodiment, a lever system is provided to transmit the force generated by the actuators to the slave pistons of the clamping elements. Depending on the design of the individual lever or the position of the pivot shaft, the force can be additionally amplified by means of the lever system. Therefore, it is possible to further reduce the energy required for the actuators.

In order to achieve a particularly simple design and to reduce the number of external connections, in a particularly preferred embodiment an electromagnetic double-actuator system is used. In this case, clamping magnets and/or pot magnets are particularly advantageous. In an alternative preferred embodiment, the actuator system comprises pneumatic and/or hydraulic cylinders which produce the force that acts on the slave pistons.

In an advantageous embodiment, an additional booster chamber is used in the case of the pneumatic and/or hydraulic cylinders, in order to also accelerate the cylinders when braking so as to further increase the braking action and decrease the reaction time.

The advantages achieved by the invention consist in particular in that, by using a double-actuator system having electromagnetic actuators, significantly lower input voltages can be used. In this case, low voltages, for example 24 V connections, can be utilised, while still complying with safety requirements and norms. The use of low voltages not only leads to a reduction in the energy required and therefore to cost savings during continuous operation of the clamping or braking device, but also to the fact that health and safety at work guidelines can be met more easily, since the system is not operated at high voltages and the component part does not get noticeably hot.

A particularly compact design is also made possible when using a pneumatic and/or hydraulic actuation system by dividing the force between two actuators, since the individual actuators can be smaller.

One embodiment of the invention will be explained in more detail with reference to the drawings, in which:

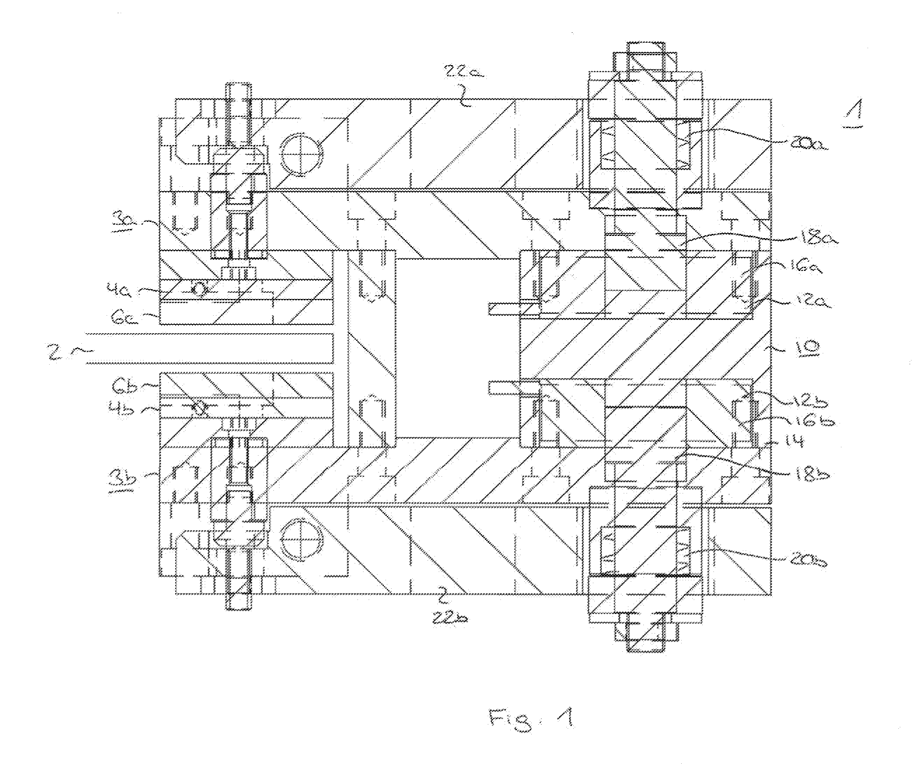

FIG. 1 shows a clamping or braking element having a double actuator comprising pot magnets, and

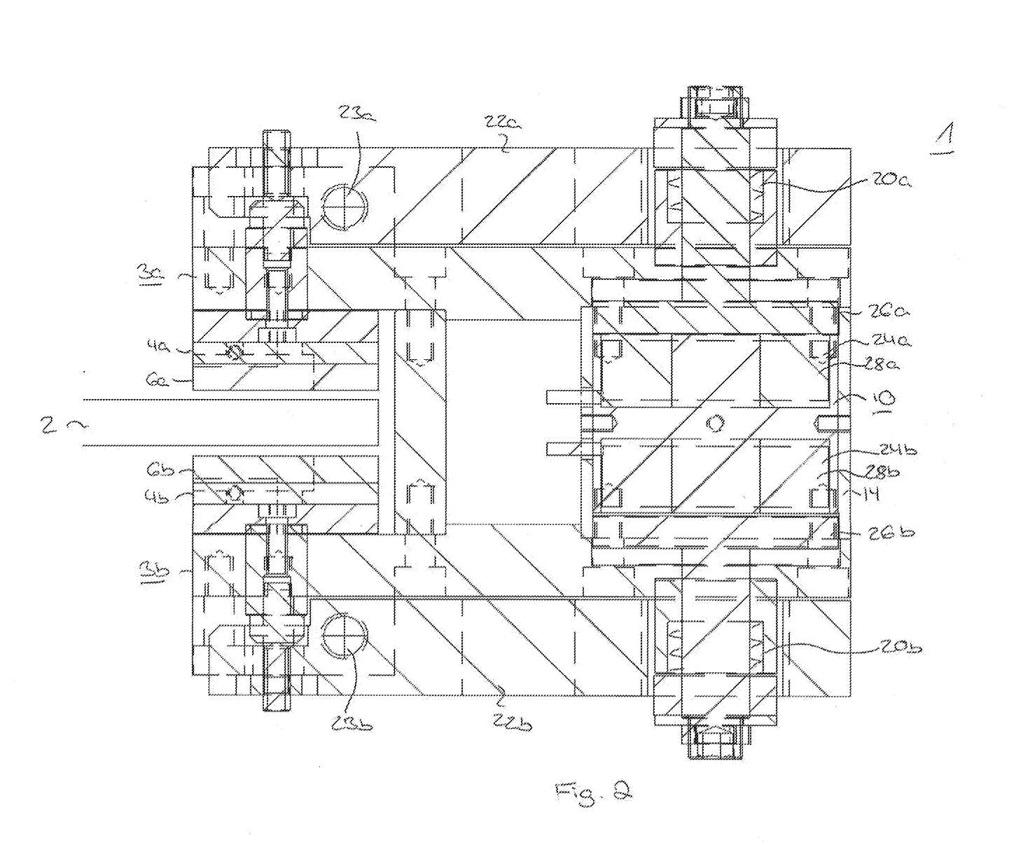

FIG. 2 shows a clamping or braking element having a double actuator comprising clamping magnets, and

FIG. 3 shows a clamping or braking element having a double-actuator comprising pneumatic and hydraulic cylinders.

Identical parts are provided with the same reference numerals in all the figures.

The clamping or braking device 1 according to FIG. 1 is designed, for example, to brake a rotating brake disc 2. In general, the clamping or braking device 1 can, however, also be used to brake other elements such as rails or bars, or to clamp component parts to said elements. In the embodiment according to FIG. 1, two clamping elements 3a, 3b are provided to brake the brake disc 2, each of which elements comprise a slave piston 4a, 4b. These slave pistons 4a, 4b each comprise a brake pad 6a, 6b which can be brought into frictional contact with the brake disc 2 when braking. The slave pistons 4a, 4b are arranged on either side of the brake disc 2 in this case, so that the clamping or braking device 1 almost surrounds the brake disc. In this case, the clamping or braking device 1 is formed as a passive braking system, which means that a force has to be exerted on the slave pistons 4a, 4b in order that the brake pads 6a, 6b are not in contact with the brake disc 2. The clamping or braking device 1 therefore comprises respective spring elements 20a, 20b which, when the slave pistons 4a, 4b are opened, are pre-tensioned by the force applied, and when braking, i.e. when the force is not applied, accelerate the slave pistons 4a, 4b in the direction of the brake disc 2 and press the brake pads 6a, 6b against the brake disc 2. In another embodiment, the clamping elements 3a, 3b can also comprise additional spring elements, which are arranged for example so as to be aligned with the guide path of the slave pistons 4a, 4b, so that tilting of the slave pistons 4a, 4b during braking is prevented.

The force acting on the slave pistons 4a, 4b for opening the clamping or braking device 1 is generated by means of a double-actuator system 10. In the embodiment according to FIG. 1, the double-actuator system 10 comprises two actuators which are formed as pot or lifting magnets 12a, 12b and are arranged in a magnet housing 14. When a voltage is applied, a magnetic field is generated by magnet coils 16a, 16b, so that magnet armatures 18a, 18b are drawn into the magnet coils 16a, 16b. In this case, each magnet armature 18a, 18b pre-tensions the above-mentioned spring system 20a, 20b. The stroke or the force of the magnet armatures 18a, 18b is transmitted to the slave pistons 4a, 4b by means of respective lever systems 22a, 22b. In this case, when the pivot shaft 23a, 23b is correspondingly positioned, the force acting on the slave pistons 4a, 4b can be further increased. When the voltage is not applied, the magnetic field in the magnet coils 16a, 16b reduces, as a result of which the magnet armatures 18a, 18b are no longer drawn into the magnet coils 16a, 16b. As a result of the pre-tensioned spring system 20a, 20b, an opposing force is now transmitted to the slave pistons 4a, 4b and the slave pistons 4a, 4b or the brake pads 6a, 6b are brought into contact with the brake disc 2 by the possible additional spring system in the clamping elements 3a, 3b.

In contrast to the embodiment according to FIG. 1, in place of the pot magnets, clamping magnets 24a, 24b, which are arranged in the common magnet housing 14, are provided in the clamping or braking device 1 according to FIG. 2. When a voltage is applied, the magnet armatures 26a, 26b are attracted to the end face of the magnet coils 28a, 28b. As already mentioned above, the attraction of the magnet armatures 26a, 26b causes the spring system 20a, 20b to be pre-tensioned and the slave pistons 4a, 4b to be released from the brake disc 2 by the lever system 22a, 22b. As is also the case in the clamping or braking device according to FIG. 1, the magnet armature is no longer attracted to the magnet coil when no voltage is applied, and therefore the brake pads 6a, 6b of the slave pistons 4a, 4b are pressed against the brake disc 2 by the spring systems 20a, 20b and the lever systems 22a, 22b, and the brake disc 2 is therefore braked.

In the clamping or braking device according to FIG. 3, a pneumatic and/or hydraulic cylinder system is used as actuators 12a, 12b in place of the electromagnetic actuators in the embodiments according to FIG. 1 and FIG. 2. In this case, only master pistons 30a, 30b are used in place of the magnet armatures and are moved by means of a pneumatic or hydraulic medium that is introduced into a pressure chamber 32a, 32b. These master pistons 30a, 30b also interact with the lever systems 22a, 22b and cause the spring systems 20a, 20b to be pre-tensioned and the clamping or braking device to open when the pneumatic and/or hydraulic pressure is applied. In the event that the pneumatic and/or hydraulic pressure is not applied, the slave piston 4a, 4b is pressed in the direction of the brake disc 2 by means of the pre-tensioned spring system 20a, 20b and the lever system 22a, 22b, as in the other embodiments. This can be further increased by a booster, in which case, when braking, a pneumatic and/or hydraulic medium is poured into a booster chamber 34, and thus pushes the master pistons 30a, 30b apart, as a result of which the clamping or braking movement of the slave pistons 4a, 4b is actively assisted and therefore the clamping or braking action is increased and the reaction time decreased.

### LIST OF REFERENCE NUMERALS

1 clamping or braking device
2 brake disc
3a, 3b clamping elements
4a, 4b slave pistons
6a, 6b brake pads
10 double-actuator system
12a, 12b pot or lifting magnet
14 magnet housing
16a, 16b magnet coil
18a, 18b magnet armature
20a, 20b second spring system
22a, 22b lever system
23a, 23b pivot shaft
24a, 24b clamping magnet
26a, 26b magnet armature
28a, 28b magnet coils
30a, 30b master piston
32a, 32b pressure chamber
34 booster chamber

1. Safety clamping and/or safety braking device (1) for machine elements, comprising at least two clamping elements (3a, 3b) each having a slave piston (4a, 4b) that triggers the clamping and/or braking action and an actuator system for generating a force which is transmitted to the slave pistons (4a, 4b), characterised in that the actuator system is designed as a double-actuator system (10),

2. Safety clamping and/or safety braking device (1) for machine elements according to claim 1, characterised in that the clamping elements (3a, 3b) are formed as passive clamping elements.

3. Safety clamping and/or safety braking device (1) for machine elements according to either claim 1 or claim 2, characterised in that respective lever systems (22a, 22b) are provided to transmit the force from the double-actuator system (10) to the slave pistons (4a, 4b).

4. Safety clamping and/or safety braking device (1) for machine elements according to any of claims 1 to claim 3, characterised in that the double-actuator system (10) is formed as an electromagnetic actuator system.

5. Safety clamping and/or safety braking device (1) for machine elements according to claim 4, characterised in that the double-actuator system (10) comprises at least two clamping magnets (24a, 24b).

6. Safety clamping and/or safety braking device (1) for machine elements according to claim 4, characterised in that the double-actuator system (10) comprises at least two pot magnets (12a, 12b).

7. Safety clamping and/or safety braking device (1) for machine elements according to any of claims 1 to 3, characterised in that the double-actuator system (10) comprises at least two pneumatic and/or hydraulic cylinders.

8. Safety clamping and/or safety braking device (1) for machine elements according to claim 7, characterised in that the double-actuator system (10) comprises a booster chamber (34).
